(19) United States
(12) Patent Application Publication
(10) Pub. No.: US 2003/0165128 A1
(43) Pub. Date: Sep. 4, 2003

(54) Interactive communications system coupled to portable computing devices using short range communications

(76) Inventors: Rajendra Sisodia, Lexington, MA (US); David Moschella, Boston, MA (US); Dipinder Singh, Cambridge, MA (US); Vinit Nijhawan, Lexington, MA (US); Rohit Arora, Sudbury, MA (US); Jawahar Tembulkar, Bedford, MA (US)

Correspondence Address: CHARLES G. CALL, 68 HORSE POND ROAD, WEST YARMOUTH, MA, 02673-2516, US

(21) Appl. No.: 09/904,699

(22) Filed: Jul. 13, 2001

Related U.S. Application Data
(60) Provisional application No. 60/218,374, filed on Jul. 13, 2000.

(51) Int. Cl. H04Q 7/24; H04L 12/28

(52) U.S. Cl. 370/338; 370/401

(57) ABSTRACT

An “access point” data terminal device is positioned at or incorporated into a display or acting as a standalone device accessible to a user transporting a portable computing device. A short-range communication link is provided by an IrDA infrared transceiver, or a Bluetooth radio transceiver, or both, to permit data and programs to be exchanged between the access point and nearby portable computing devices. The access point is provided with a program installation mechanism that is manually operable by the user when the portable computing device is positioned near the access point to download and install application software which programs the portable computing device to utilize the services made available at the access point. A longer-range communications mechanism, preferably implemented as a PCMCIA communications card selected to connect to an available network or communications facility, enables the access terminal to act as a bridge coupling nearby portable computing devices to remote computers. The longer range communications system may further provide an Internet connection to the portable device, permitting the portable device to exchange E-mail, exchange information with a selected Web server, synchronize data file content, and to access and use other available resources. A surface mounted fractal antenna may be used to advantage to facilitate wireless communications.

### CROSS-REFERENCE TO RELATED APPLICATION

This application claims the benefit of the filing date of the copending U.S. Provisional Patent Application Serial No. 60/218,374 filed by applicants on Jul. 13, 2000.

### REFERENCE TO COMPUTER PROGRAM LISTING APPENDIX

A computer program listing appendix is stored on each of two duplicate compact disks that accompany this specification. Each disk contains computer program listings that illustrate implementations of the invention. The listings are recorded as ASCII text in IBM PC/MS DOS compatible files that have the names, sizes (in bytes) and creation dates listed below:

| File Size | Date Created | File Name |
|---|---|---|
| 2,374 | Jul. 11, 2001 | ButtonMonitor.cc |
| 22,166 | Jul. 11, 2001 | B2C.h |
| 10,506 | Jul. 11, 2001 | B2Pnew.cc |
| 50,744 | Jul. 11, 2001 | B2Pnew.h |
| 4,118 | Jul. 11, 2001 | BridgeMonitor.cc |
| 15,737 | Jul. 11, 2001 | B2C.cc |
| 10,369 | Jul. 11, 2001 | VedasLib.pm |
| 1,142 | Jul. 11, 2001 | pcicm |
| 56,312 | Jul. 11, 2001 | pcic.pl |
| 74,600 | Jul. 11, 2001 | pcih |
| 527 | Jul. 11, 2001 | NetPrefs.h |
| 615 | Jan. 11, 2000 | AdAliveRsc.cpp |
| 19,169 | Jul. 11, 2001 | CityListForm.cpp |
| 2,403 | Jul. 11, 2001 | HuffExpBufUtils.cpp |
| 1,459 | Jul. 11, 2001 | HuffExpBufUtils.h |
| 2,618 | Jul. 11, 2001 | HuffNode.cpp |
| 15,543 | Jul. 11, 2001 | NetPrefs.c |
| 156,290 | Jul. 11, 2001 | AdAlive.c |
| 613 | Jan. 11, 2000 | AABootstrapRsc.c |
| 49,605 | Jul. 11, 2001 | AABootstrap.c |

### COPYRIGHT STATEMENT

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to electronic data exchange mechanisms and more particularly to an interactive communications device capable of communicating with devices such as a personal digital assistants (PDAs), notebook computers, cellular telephones, computer games, electronic books, pagers, etc., here generically called “portable computing devices,” via a short range communication pathway, such as an infrared or short range radio link

### BACKGROUND AND SUMMARY OF THE INVENTION

As electronic device technology has become more advanced, the size and cost of computational devices has decreased dramatically while their capabilities have increased. As a result, the use of portable electronic devices such as laptops and hand-held computers, personal digital assistants, and advanced cellular phones and paging devices has become increasingly widespread. Many of these devices include the ability to communicate with host computers via infrared or short-range radio networks. Increasingly, such devices may be coupled to external data networks using advanced wireless protocols supported by numerous device and communication service vendors, such as the IrDA Protocol (www.irda.org) and the Bluetooth Protocol (www.bluetooth.com).

It is a principal object of the present invention to provide communications facilities that provide information and data processing services to the users of these portable computing devices.

The present invention provides methods and apparatus for providing information and data processing services to portable computing devices. An “access point” data terminal device is positioned at a location accessible to a user transporting a portable computing device. The access point may be advantageously incorporated into or located near to a display so that the display can interactively communicate with nearby portable computing devices.

The short range communication link thus couples the access point to the portable computing device that preferably includes means operable by the user for downloading interfacing application programs from the access point to the portable computing device, thereby programming the portable computing device to utilize the resources provided by the access point. This program installation mechanism preferably includes an actuator at the access point that is operable by the user when the portable computing device is positioned near the access point. The program may however be independently installed on the portable computing device by other means The short-range communication link preferably takes the form of a bidirectional infrared communications link, or a bidirectional short-range radio link, or both. The infrared link preferably operates in accordance with the standard IrDA protocol while the short-range radio link preferably conforms to the Bluetooth protocol. The access point may be advantageously provided with both an IrDA and a Bluetooth transceiver to permit communications with diverse portable devices. Data files and programs are preferably transferred between the access point and the portable computing device via the short-range link using the OBEX object exchange protocol or other suitable protocol, such TinyTP.

The access point terminal may further include a mechanism for establishing a longer-range communication link to one or more remote computers. This longer-range link may be implemented as a local or wide area wireless or wired network. A local “campus” server connected to this area network may be advantageously used to administer and monitor satellite access points, to store data and to provide programs, computational and communications services to the satellite access points and, through these access points, to portable computing devices. The campus server or a separate router may be used to provide an Internet connection to each access point, which acts as a bridge to the portable computing devices. This Internet connection permits the portable computing device to exchange E-mail, utilize information and services available on the World Wide Web, and to access other resources made available through the Internet.

The communications pathway thus provided between portable computing devices and remote computers permits data synchronization to be performed by the user whenever the portable device is within range of the access point. In this way, the content of data files may be updated to insure that like data is stored on both the portable device and a designated remote computer.

The longer-range communications link, like the short-range link, may take a variety of forms depending upon the availability of different networking and communications services. Accordingly, the access point terminal is preferably configurable to work with a variety of different longer-range communications facilities and protocols. To this end, the access point terminal preferably employs a modular, interchangeable longer range communications device, which may be a wireless and wired network adapter, dial-up modem, a cellular communications device, or the like As contemplated by the invention, public displays, such as billboards, kiosks, display cases and other publicly viewable displays or objects may be equipped with an access point terminal for communicating with the portable devices carried by users as they pass by and are presented with the display. In a preferred arrangement, the access point terminal functions as a bridge for establishing a short range communication link with the user's portable device, typically using an infrared or short range radio transmission pathway, and further establishing a longer range communications link to one or more remote host computers via a wired or wireless local area or wide area network and/or the Internet. One or more of the remote computers may provide a connected user device with interactive data services that relate to the subject matter presented by a billboard or other public display. For example, the access point terminal may provide additional information about a product advertised on a billboard, the additional information taking the form of one or more files of downloadable data files, streaming audio or video, or web pages that present further information concerning the advertised product. In addition, the access point terminal may be used by the display sponsor to acquire contact data or other information from the user of the portable device to permit follow-on communications to be established between the product vendor and the device user, or the bridge device may provide an Internet connection to the user device, permitting email or web access, as well as direct communications and transactions between the sponsor and the user.

These and other objects, features, applications and advantages of the present invention may be more clearly understood by considering the following detailed description of illustrative embodiments of the invention. In the course of this description, reference will be made to the attached drawings and materials.

### BRIEF DESCRIPTION OF THE DRAWINGS AND THE ATTACHMENT

FIG. 1 illustrates the basic components of an illustrative system contemplated by the invention for gaining the attention of and communicating with persons carrying communication-capable portable devices in public places;

FIG. 2 is a perspective view of an access point terminal which may placed on or near a public display for establishing a first, short range communication link with a nearby portable device and a second, longer range communication link to a communications network; and

FIG. 3 is a schematic block diagram of the principle components used to implement the bridge device seen in FIG. 2.

### DETAILED DESCRIPTION

Overview

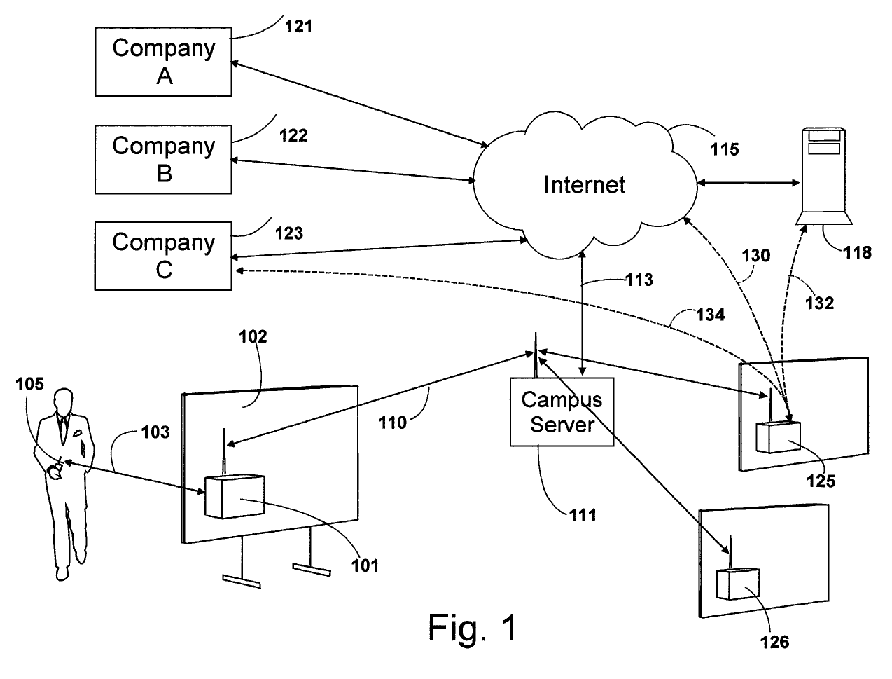

FIG. 1 illustrates the basic functional components of a communications system, which embodies the invention. An interactive communications terminal 101, called an “access point,” is positioned near or forms a part of a billboard, kiosk, display case or other public space display (generically referred to as a “display”) and seen at 102 in FIG. 1. The access point 101 provides a short range communication link 103 for nearby personal digital assistants (PDAs), notebook computers, phones, electronic game devices, electronic books, pagers, etc., here generically called “portable computing devices,” one of which is illustrated by the hand-held device seen at 105. The short-range communications pathway 103 between the access point 101 and the portable computing device 105 may consist of an infrared link or an ultra high frequency radio link. As described in more detail later, an access point may advantageously support both infrared and short-range radio links to portable devices, and be configurable to employ one or more selected, longer-range communications facilities for exchanging data with remote computers.

The display 102 located at or near the access point 101 may be used to attract the attention of passers-by who are transporting portable devices capable of communicating with the access point. The display 102 may also be used to advertise goods or services, or otherwise exhibit visual information to passers by, and the access point 101 and short-range communications link 103 can be used to electronically transmit information, which supplements the information visually presented by display 102. In addition, or in the alternative, the access point 101 may provide passers-by with needed communications services, such as an Internet connection for email, World Wide Web access, or data exchange with a designated remote computer, and thus serve to direct the attention of users to the information visually exhibited by the display 102.

The access point 101 may optionally be linked to a other computing resources, r, such as the campus server seen at 111 in FIG. 1, by a longer-range communications link 110. The campus server 111 is provided with a connection 113 to the Internet 115 which provides a data communications path from the campus server 111 to a “home server” 118, to remote computers operated on behalf of participating companies as indicated at 121, 122 and 123, or to other computers (not shown) connected to the Internet 115. The campus server is also connected other access points as illustrated at 125 and 126. Using a single campus server of type seen at 111 in FIG. 1 to support numerous satellite access points, a large area, such as an airport terminal building, a shopping mall, or a trade show may be served, providing users of portable computing devices with convenient public access to data and computing services at many locations within the “campus” area. It should be noted that the access point(s) can be directly connected to the Internet as indicated at 130, to a home server as indicated at 132, to computers operated on behalf of participating companies as indicated at 134, or to other computers connected to the Internet, without the use of a campus server

The longer range links between the campus server 111 and the access points 101, 125 and 126 is preferably provided by a wireless LAN network using a standard protocol, preferably complying with the IEEE 802.11x (x means it can be a, b, g, etc.) standard, although other wireless protocols such as the CDPD (Cellular Digit Packet Data), the MCDN (Micro-Cellular Data Networking Technology) used in the Ricochet Network, GSM, PCS, CDMA, Mobitex, iMode packet data modem, FLEX and other non-IP networks etc. may be employed. Alternatively, a conventional wired network, such as a wired Ethernet, token ring, peer-to-peer, power line, phone line, modem/POTS, serial, parallel, GPIB, LonWorks, fiber-optic, USB, Firewire, etc.) may be used to provide the longer-range communication.

As contemplated by the invention, an access point as seen at 101 may be used to provide a rich variety of information, processing services and connectivity to a portable user device which is carried nearby. One or more interface applications programs executed by the portable user device are employed to exchange data or to access services provided by a host computer that may, depending upon the specific application being used, be the processor in the access point 101, the processor at the campus server 111, the home server 118, one of the participating company computers 121, 122 or 123, or any other remote host. Thus, the access point 101 and/or the campus server 111 may provide computing services, may store data or programs which can be made available to portable devices on request, may act as a cache or temporary store for data supplied from a remote computer, or may act as a direct interconnection (bridge) in a communications pathway which links a portable user device to a remote host. Services that may be made available in this way to the portable user device include Internet communications services (email or Web connections) that permit portable computer users who are in public places (airline terminals, shopping malls, trade shows, hotel lobbies, etc.) to read and send email or access data and services via the Internet. Applications and services of this kind may use the Wireless Application Protocol (WAP), an industry-wide specification that provides an application framework and network protocols for wireless devices such as mobile telephones, pagers, and personal digital assistants (PDAs). Applications and services of this kind may be based on WAP (Wireless Applications Protocol), OBEX, and application level protocols based on the TCP/IP suite of protocols, e.g. HTTP and J2ME.

Access Point Hardware and Software

The access point terminal 101 may be installed internally or externally to a display, such as a billboard, kiosk or display case, or may used separately from a display as a standalone device positioned at a conveniently accessible location such as a hotel lobby or trade show booth or within an enterprise or campus such as a university, hospital or office building. When used with a display for advertising goods or services, the access point may provide passers by with additional information concerning the goods or services advertised or exhibited by the display, may permit electronic transactions to be performed between the user of the portable computing device and a remote host computer operated on behalf of the display sponsor, or may provide valuable services or connectivity to the user, thus serving to attract the user to the display.

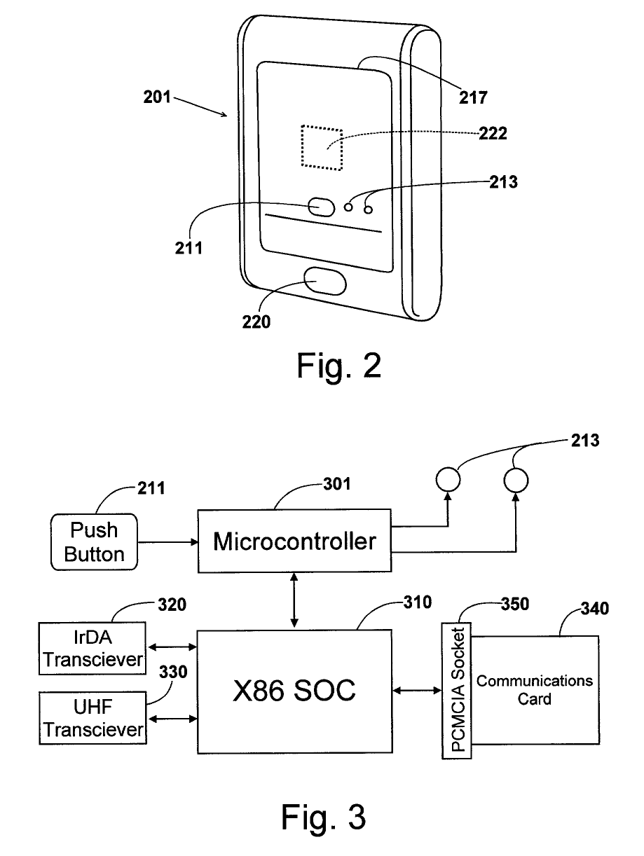

The access point hardware preferably takes the form of a configurable, multifunction device in a compact housing as illustrated in FIG. 2. The housing indicated generally at 201 exposes a single pushbutton control seen at 211 and two indicator lights at 213. A rectangular label 217 covers the outer face of the housing and preferably includes a distinctive icon or the like which identifies the access point to passers by and provides printed instructions to first time users explaining how to download interface application programs directly from the access point terminal.

An infrared transducer 220 is positioned on the front face of the housing 201 to be visible to the corresponding infrared transducer in a nearby portable computing device.

A surface mounted fractal antenna may be used to provide UHF communications without the need for a separate antenna. The fractal antenna may be positioned beneath the label 217 as shown by the dashed line rectangle 222. The fractal antenna at 222 consists of one or more conductive microstrips arranged in a fractal pattern formed on a planar substrate as described in detail in U.S. Pat. Nos. 6,104,349, 6,127,877 and 6,140,975 issued to Nathan Cohen, the disclosures of which are hereby incorporated by reference.

The housing 210 contains the electronic components shown in the block diagram of FIG. 3. The pushbutton 211 is connected to an input pin of a microcontroller 301 which controls two indicator lamps 213, one of which is illuminated when the access point is powered ON and available for use, and the second of which is illuminated when the access point is transmitting or receiving data from a nearby portable computing device. The indicator lamps 213 provide visual confirmation to the user that the access point terminal is functioning as intended.

The microcontroller 301 detects when the pushbutton 211 is actuated by a user and sends a control signal to a SOC “System on a Chip” seen at 310. The SOC 310 provides a complete computer system, including an Intel 486 processor, a memory subsystem for storing core operating system programs as well as data and application programs which may be downloaded to and used by connected portable computing devices.

The access point hardware may be readily configured to communicate at longer range with remote computers by selecting and installing an appropriate PCMCIA communications card 340 in the card socket 350. The installed card may take the form of an 802.11x wireless network adapter connected to the fractal antenna seen at 222, a wide area wireless adapter, a wired network adapter, a modem card connected to a dialup telephone line, or another type of card adapted to provide connectivity to an available communications facility such as a local or wide area network. Note that a given campus server may employ a variety of different communications facilities to link to different satellite access points; for example, access points which are within range of an 802.11b wireless network may use that facility while other satellite access points may be connected using a dialup telephone connection. A removable panel (not shown) on the rear face of the access point terminal housing 201 provides access to the enclosed electronics to facilitate installation and replacement of the PCMCIA communications card. The rear face plate also provides access for a conduit for delivering power to the access point, as well as wired network access.

When power is initially applied to the access point, an initialization program is executed to configure the system for operation and, when initialized, the SOC 310 signals the microcontroller 301 to illuminate one of the lamps 213 to indicate that the access point is ready for use.

Portable computing devices, including PDA's, laptop computers, and the like commonly include infrared or short-range radio transceivers for exchanging data and/or commands with other electronic devices electronically. Infrared transceivers typically employ the IrDA Data signaling protocol which defines a standard for an interoperable universal two way cordless infrared light transmission data port. IrDA technology is currently installed in large numbers of electronic devices including laptop and notebook computers, PDAs, pocket PCs, digital cameras, cellular phones, pagers, electronic books, gaming devices, electronic wallets, and other mobile devices. The more recently adopted Bluetooth Specification provides a similar standard data communication protocol for providing short-range radio data communications between electronic devices. Because both infrared and short-range radio communications are expected to be in widespread use, the access point hardware preferably includes both an infrared IrDA transceiver 320 and a UHF Bluetooth transceiver 330 as seen in FIG. 3.

Portable Computing Device Application Software

Portable computing devices of many kinds may employ the access point as a resource. For example, a conventional communicating PDA may be provided with a small software application program that allows the PDA user one-click access to information via the access point contemplated by the invention. This software applet may make use of a conventional Internet microbrowser in the PDA to communicate via the access point and the Internet to a remote Web server. For example, Windows CE and PocketPC PDAs have the Pocket Internet Explorer microbrowser that works well with standard HTML code from most Web sites, and third-party microbrowsers, such as AvantGo and Blazer, are readily available for PDAs employing the Palm OS. Other portable devices such as smart phones, the Rocket eBook, Nintendo Game Boy and MP3 music players may be supported with microbrowser interfaces). Alternatively, special purpose application programs may be installed on the portable computing device to permit the user to select available services and information, view data, exchange email and perform other functions.

Application programs that can be executed on a portable computing device to connect to desired resources may be downloaded by the user directly from an access point terminal. When the pushbutton 211 on the access point terminal is manually actuated by a user carrying a portable computing device, the microcontroller 310 signals the SOC 310 which responds by establishing communications with the portable device using either the infrared IrDA transducer 320 or the UHF signaling transducer 330. After a short-range communications link has been established between the access point and a nearby portable computing device using either of the transceivers 320 or 330, the SOC 310 executes a program to download an installation program via the active transceiver to the portable computing device.

After the transfer is complete, the downloaded installation program executes on the portable computing device to request predetermined or user-selected application programs and/or data files from the access point. Programs and data files are preferably transferred using various layers of the IrDA and Bluetooth protocol stacks, as well as application level protocols such as OBEX, and others such as HTTP and J2ME which is based on the TCP/IP suite of protocols. When a designated application program has been successfully downloaded from the access point to the portable computing device, it may be automatically launched to provide the user with desired data, computational services or a connection to the Internet.

After the desired application programs are successfully installed on the portable computing device, the installation program may be deleted to conserve storage space. Note that the application programs needed for accessing resources via an access point may also be installed on a portable computing device in other ways; for example, the application programs may be first transferred to the user's personal computer from a designated Web server using the Internet, or provided on a media copy such as a floppy disk or CD ROM, and then downloaded into the portable computing device using at the portable computing device's docking station connected to a PC. In addition, the application programs or programs may be shared by one user transferring a copy of the application program from his or her portable device directly to another user's device using IrDA or Bluetooth transmission.

Once the application program or programs have been installed, the portable computing device may be used to select and obtain selected data or services whenever the portable device is within infrared or UHF range of an access point. To make use of an access point, the user is instructed to perform the following steps after transporting the portable computing device to within a predetermined distance (e.g. three feet): (1) turn on the portable device; (2) launch the previously installed application program to display the program's main menu; and (3) select one of the displayed optional functions. These available functions may include, for example:

(a) Obtaining additional information about the products or services offered by the sponsor of the display located at the access point, supplying information to the sponsor, or performing transactions with the sponsor. To this end, the user may be automatically connected to a Web server operated by the sponsor.

(b) Obtaining information relevant to the location of the access point, such as a city, airport or trade show guide.

(c) Sending or receiving E-mail from using the POP3/IMAP and/or SMTP protocols to exchange E-mail messages with a remote E-mail server.

(d) Synchronizing the content of one or more designated data files stored in the portable device with the content of a similar files on a designated remote computer, thus insuring that the data on the portable computing device and on the remote computer both reflect the current version of the designated data. In addition, the access point may be used as a conduit for transferring and synchronizing data and files used to implement proprietary systems such as the enterprise systems offered by Avantgo, Inc. of Hayward, Calif. and the location-based systems offered by Vindigo, Inc. of New York, N.Y.

(e) Obtaining instructions and “help” files to facilitate the use of the communications system and the application program(s).

(f) Sharing application and data files with other portable computing device users using direct file transfer between these devices, there by facilitating and promoting the use of the system by other portable device users.

Campus Server Hardware and Software

A campus server as seen at 111 in FIG. 1 may be connected to serve, manage and monitor numerous satellite access points within an area (called a “campus”) such as an airport, a shopping mall, a trade show, or the like. A wireless network, such as an IEEE 802.11 b network, may be used to connect each access point to the campus server. The campus server may be implemented, for example, by a Linux based server and act as a repository for data used by the access points.

The campus server is further programmed to administer and monitor each of the access points on the network and employs SSH, SCP and secure socket programs that use public key cryptography to ensure secure transfer of data over insecure communication channels, providing more secure communications with remote servers than conventional Telnet and FTP methods.

Central “Home” Computer Hardware and Software

The “home server,” seen at 118 in FIG. 1, operates as the master database for the system and administers the overall distributed computing network. The home server operates as a master repository for log files from portable computing devices and for transactions log files from access points, as well as for content files provided by the advertising sponsors and the like which may be transmitted to the home server via the Internet from other computers, such as the company computers seen at 121, 122 and 122. The home server seen at 118 also distributes information files, such as city and airport guides, to campus servers or directly to access points (with the home server functioning as a campus server). The home server provides redundant storage for data, which is also stored in campus servers, improving system reliability. The home server may also provide user registration and configuration, downloadable application programs executable on portable devices, advertiser customer relationship management and content creation, usage monitoring, and system metrics. The home server may provide easy-to-use methods for advertiser customers to create content for downloading to PDAs.

Conclusion

It is to be understood that the methods and apparatus described above are merely illustrative applications of the principles of the present invention. Numerous modifications may be made to the disclosed systems, components and techniques without departing from the true spirit and scope of the invention.

What is claimed is:

1. The method of transferring programs and data to a portable programmable data processing device from a host computer comprising, in combination, the steps of:
placing said host computer at location accessible to a user transporting said portable computing device,
accepting an installation command from said user at said host computer when said user and said portable data processing device are near said host computer
executing a program at said host computer in response to said installation command to establish a short range bi-directional communications link between said host computer and said portable data processing device and to download a communications program from said remote computer to said portable data processing device via said short range communications link,
executing said communications program on said remote data processing device to transfer one or more specified files from said host computer to said portable data processing device.

2. The method set forth in claim 1 wherein said step of accepting an installation command comprises using an actuator at said host computer manually operable by said user.

3. The method as set forth in claim 1 wherein said one or more specified files include an application program executable by said portable computing device.

4. The method as set forth in claim 3 further including the step of automatically executing said application program on said portable computer device after it is transferred.

5. The method as set forth in claim 1 wherein said short-range bidirectional communications link is an infrared communications link

6. The method as set forth in claim 5 wherein said infrared communications link operates in accordance with the IrDA Protocol.

7. The method as set forth in claim 6 wherein said one or more specified files are transferred from said host computer to said portable computing device using the IrDA Object Exchange Protocol.

8. The method of claim 1 wherein said short-range bi-directional communications link is an ultra high frequency radio link.

9. The method of claim 8 wherein said short-range bi-directional communications link operates in accordance with the Bluetooth Specification.

10. The method as set forth in claim 1 further comprising establishing longer range communications link for transferring programs and data between one or more remote computers and said portable computing device via said host computer.

11. The method as set forth in claim 8 wherein said longer range communications link is a network connection to a server, which stores programs and data for use by said portable computing device.

12. The method as set forth in claim 11 wherein said network connection is a wireless network connection.

13. to user request for executing said application program on said portable computing device to prov Apparatus for providing information and data processing services to a mobile user which comprises, in combination,
a portable programmable computing device carried by said user,
a host computer positioned at a location accessible to said user,
a short range communication link coupling said portable computing device to said host computer,
means operable by said user when said portable computing device is near said host computer for causing said host computer to download a communications program via said short range communication link to said portable communications device,
means for initiating the execution of said communications program on said remote computing device after said download to transfer an applications program from said host computer to said portable computing device, and
means for initiating the execution fo said applications program to provide said information and data processing services to said mobile user.

14. Apparatus as set forth in claim 13 wherein said means for causing said host computer to download said communications program comprises an actuator at said host computer manually operable by said user when said user and said portable computing device are near said host computer.

15. Apparatus as set forth in claim 13 wherein said short range communications link is a bi-directional infrared communications link.

16. Apparatus as set forth in claim 15 wherein said bi-directional infrared communications link operates in accordance with the IrDA Protocol.

17. Apparatus as set forth in claim 16, wherein said applications program is transferred from said host computer to said portable computing device using the IrDA Object Exchange Protocol.

18. Apparatus as set forth in claim 13, wherein said short-range bi-directional communications link is an ultra high frequency radio link.

19. Apparatus as set forth in claim 18, wherein said short-range bi-directional communications link operates in accordance with the Bluetooth Specification.

20. Apparatus as set forth in claim 13, further comprising a longer range communications link for transferring programs and data between one or more remote computers and said portable computing device via said host computer.

21. Apparatus as set forth in claim 20 further comprising a server for storing programs and/or data for use by said portable computing device, said server being connected to said portable communications device via said longer range communications link, said host computer, and said short range communications link.

22. Apparatus as set forth in claim 21, wherein said longer-range communications link is a local area network.

23. A communications bridge for establishing a bi-directional communications link between a portable computing device carried by a user and a remote computer, said bridge being positioned at a location accessible to said user and comprising, in combination,
a first transceiver for establishing a short range bi-directional communications link to said portable computing device when said portable computing device is carried near to said bridge by said user,
a second transceiver for establishing a longer range bi-directional communications link to said remote computer,
an actuator manually operable by said user,
a processor connected to said first transceiver and responsive to the operation of said actuator by said user when said user and said portable computing device are near to said bridge for downloading a communications program executable by said portable computing device and for thereafter controlling said first and said second transceivers to establish said communications link.

24. A communications bridge as set forth in claim 23 wherein said short-range communications link is an bi-directional infrared communications link.

25. A communications bridge as set forth in claim 23 wherein said bi-directional infrared communications link operates in accordance with the IrDA Protocol.

26. A communications bridge as set forth in claim 23, wherein said short-range bi-directional communications link is an ultra high frequency radio link.

27. A communications bridge as set forth in claim 26, wherein said short-range bidirectional communications link operates in accordance with the Bluetooth Specification.

28. A communications bridge as set forth in claim 24 further including a third transceiver for establishing a short range bi-directional ultrahigh frequency radio communications link with a portable computing device.

29. A communications bridge as set forth in claim 28, wherein said bi-directional infrared communications link operates in accordance with the IrDA Protocol and wherein said short range bi-directional ultrahigh frequency radio communications link operates in accordance with the Bluetooth Specification.

30. An interactive publicly viewable display for attracting the attention of and providing data services to a user transporting a portable computing device into the vicinity of said interactive display, said interactive display comprising, in combination,
means for visually exhibiting displayed information to said user,
a transceiver for providing a short range communication link between said interactive display and said portable computing device, and
a processor coupled to said portable computing device via said transceiver for providing said data services.

31. An interactive display as set forth in claim 30 further comprising:
an actuator manually operable by said user, and
means responsive to the operation of said actuator by said user when said user and said portable computing device are near said interactive display for downloading a communications program executable by said portable computing device for exchanging information with said interactive display.

32. An interactive display as set forth in claim 30 wherein said short-range communications link is a bi-directional infrared communications link.

33. An interactive display as set forth in claim 32 wherein said bi-directional infrared communications link operates in accordance with the IrDA Link Access Protocol.

34. An interactive display as set forth in claim 30 wherein said short-range bi-directional communications link is an ultra high frequency radio link.

35. An as set forth in claim 34 wherein said short range bi-directional communications link operates in accordance with the Bluetooth Specification.

36. An interactive display as set forth in claim 30 further comprising a second transceiver for establishing a longer range bi-directional communications link to a remote computer and means for utilizing said first and said second transceivers for transmit data between said portable computing device and said remote computer.

37. An interactive display as set forth in claim 36 wherein said data services include email services and wherein said remote computer operates as an email server connected to the Internet.

38. An interactive display as set forth in claim 36 wherein said data services include file transfer services and wherein said remote computer operates as a file server.

39. An interactive display as set forth in claim 36 wherein said data services include file synchronization services for transferring data between said remote computer and said portable computing device to maintain equivalent content in like files locally stored at both said portable computing device and at said remote computer.
